(19) United States
(12) Patent Application Publication
(10) Pub. No.: US 2009/0228413 A1
(43) Pub. Date: Sep. 10, 2009

(54) LEARNING METHOD FOR SUPPORT VECTOR MACHINE

(75) Inventors: Dung Duc NGUYEN, Saitama (JP); Kazunori MATSUMOTO, Saitama (JP); Yasuhiro TAKISHIMA, Saitama (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KDDI CORPORATION, Tokyo (JP)

(21) Appl. No.: 12/400,144

(22) Filed: Mar. 9, 2009

(30) Foreign Application Priority Data
Mar. 7, 2008 (JP) 2008-057922

(51) Int. Cl. G06F 15/18

(52) U.S. Cl. 706/12

(57) ABSTRACT

A plural number of training vectors are randomly selected from a total of unused training vectors, and from among the selected training vectors, a vector having the largest error amount is extracted. Subsequently, the extracted vector is added to the already used training vector so as to update the training vector, and the updated training vector is used to learn the SVM. When the largest error amount becomes smaller than a certain setting value ε or when the already used training vector becomes larger than a certain value m, learning of a first phase is stopped. In learning of a second phase, the learning is performed on a predetermined number of or all of the training vectors having a large error amount.

### BACKGROUND OF THE INVENTION

1. Field of the Invention

The present invention relates to a learning method for a support vector machine, and particularly relates to a learning method for a support vector machine, in which a large amount of data sets are used.

2. Description of the Related Art

The principal process for the learning of a support vector machine (hereinafter, SVM) is to solve a quadratic programming problem (hereinafter, QP problem) given in the following equation (1) when a set of training data xᵢ (here, i=1, 2, . . . , l) which has a label yᵢ={−1, +1} is provided.

$$\begin{matrix}[ Equation 1 ] & \\ {min}_{α} L ( α ) = \frac{1}{2} {\sum }_{i , j = 1}^{l} {y}_{i} {y}_{j} {α}_{i} {α}_{j} K ( {x}_{i} , {x}_{j} ) - {\sum }_{i = 1}^{l} {α}_{i} \\ Where , {\sum }_{i = 1}^{l} {y}_{i} {α}_{i} = 0 , \\ 0 \leq {α}_{i} \leq C , i = 1 , … , l & ( 1 )\end{matrix}$$

where, K (xᵢ, xⱼ) represents a kernel function for calculating a dot product between two vectors xᵢ and xⱼ in a certain feature space, and C represents a parameter for imposing a penalty on the training data (among the various training data) in which noise entered.

The conventional SVM learning methods include a decomposition algorithm, a SMO (Sequential Minimal Optimization) algorithm, a CoreSVM, etc.

The decomposition algorithm is a method in which at the time of the SVM learning, an initial QP problem is decomposed into a plurality of small QP problems, and these small problems are repeatedly optimized. This method is mentioned in Non-Patent Documents 1 and 2 given below.

The SMO algorithm is a method in which in order to solve the QP problem, two pieces of training data are selected and the coefficients are analyzed and updated. This method is mentioned in Non-Patent Documents 3 and 4 given below.

Further, the CoreSVM is one of the SVM formats in which random sampling is used. The CoreSVM is a method in which the QP problem is converted into a mathematical-geometric MEB (minimum enclosing ball) problem and a solution of the QP problem is obtained by applying the MEB problem. This method is mentioned in Non-Patent Documents 5 and 6 given below.

Non-Patent Document 1: E. Osuna, R. Freund, and F. Girosi, “An improved training algorithm for support vector machines,” in Neural Networks for Signal Processing VII—Proceedings of the 1997 IEEE Workshop, N. M. J. Principe, L. Gile and E. Wilson, Eds., New York, pp. 276-285, 1997.

Non-Patent Document 2: T. Joachims, “Making large-scale support vector machine learning practical,” in Advances in Kernel Methods: Support Vector Machines, A. S. B. Scholkopf, C. Burges, Ed., MIT Press, Cambridge, Mass., 1998.

Non-Patent Document 3: J. Platt, “Fast training of support vector machines using sequential minimal optimization,” in Advances in Kernel Methods—Support Vector Learning, B. Scholkopf, C. J. C. Burges, and A. J. Smola, Eds., Cambridge, Mass.: MIT Press, 1999.

Non-Patent Document 4: R. Fan, P. Chen, and C. Lin, “Working Set Selection Using Second Order Information for Training Support Vector Machines,” J. Mach. Learn. Res. 6, 1889-1918, 2005.

Non-Patent Document 5: I. W. Tsang, J. T. Kwok, and P. M. Cheung, “Core vector machines: Fast SVM training on very large datasets,” in J. Mach. Learn. Res., vol. 6, pp. 363-392, 2005.

Non-Patent Document 6: I. W. Tsang, A. Kocsor, and J. T. Kwok, “Simpler core vector machines with enclosing balls” Proceedings of the Twenty-Fourth International Conference on Machine Learning (ICML), pp. 911-918, Corvallis, Oreg., USA, June 2007.

In the decomposition algorithm and the SMO algorithm, it is necessary to take into consideration all the training data in order to optimize the SVM learning, which causes the following problems: time is consumed in learning by using all the training data after the decomposition, in particular, when a large amount of the training data is non-support vectors, the efficiency is very poor. In the CoreSVM, the training data is subjected to random sampling. As a result, the learning effect becomes unstable unless a stopping condition is appropriately set.

### SUMMARY OF THE INVENTION

An object of the present invention is to provide a learning method for an SVM capable of speeding up learning while maintaining the accuracy of the SVM.

In order to achieve the object, a first feature of the present invention is that a learning method for a support vector machine (hereinafter, SVM) comprises a step of selecting two training vectors from two opposite classes to learn an SVM, a step of arbitrarily selecting a plurality of unused training vectors from a set of previously prepared training vectors to extract an unused training vector having a largest error amount, a step of adding the extracted unused training vector to an already used training vector to update the training vector, a step of learning the SVM by using the updated training vector, and a step of stopping the learning when the number of updated training vectors is equal to or more than a predetermined number or when an error amount of the extracted unused training vector is smaller than a predetermined value.

A second feature of the present invention is that a learning method for an SVM, performed after the learning the SVM comprises a step of arbitrarily selecting one training vector from a set of previously prepared training vectors, a step of adding the training vector to an already used training vector to update the training vector when an error amount of the selected training vector is larger than a predetermined value a step of learning the SVM by using the updated training vector and a step of stopping the learning when the number of unused training vectors is smaller than the previously determined number.

According to the present invention, SVM learning is possible by using training vectors having a large error amount, and thus, the SVM can be effectively learned and the learning can be speeded up. Also, the learning is stopped when the error amount in the training vector is smaller than the previously set value or when the number of unused training vectors is smaller than a certain value, and thus, the stopping condition of the learning can be appropriately set and the learning effect can be stabilized.

### BRIEF DESCRIPTION OF THE DRAWINGS

FIG. 1 is a flowchart showing a procedure of one embodiment (first phase) of the present invention.

FIG. 2 is a flowchart showing a procedure of another embodiment (second phase) of the present invention.

FIG. 3 is a graph showing that a learning time of the present invention is shorter than that in the conventional learning system.

FIG. 4 is a graph showing that a variation in classification accuracy of the present invention is smaller than that in the conventional learning system and also showing that the present invention is highly accurate.

### DETAILED DESCRIPTION OF THE PREFERRED EMBODIMENTS

The present invention provides a two-stage learning method for expanding and updating training data. The present invention is characterized in that in a first stage (first phase), an approximate solution is found as soon as possible; while in a second stage (second phase), solutions are derived one by one for all or a previously determined number “n” of training data (vectors). This will be described in the following embodiment.

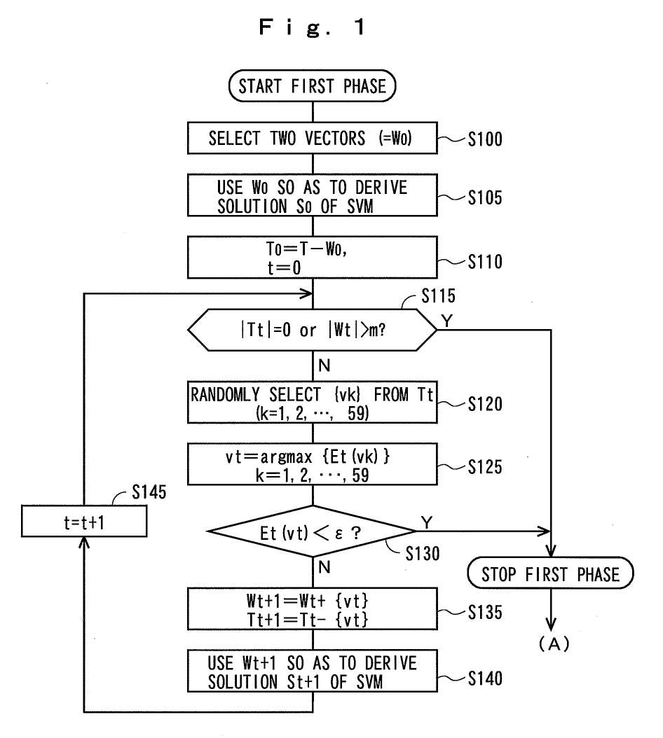

FIG. 1 is the flowchart showing the procedure of one embodiment of the present invention, showing a process procedure of the first stage (first phase). At step S100, as a set (hereinafter, referred to as W0) of initial training vectors (or training data), two vectors are selected. When the vectors (or data) are classified into two classes, arbitrary vectors can be selected from two opposite classes. It is noted that in the experiment of the present inventors, it has been ascertained that the result of SVM learning does not depend on the selection of two vectors.

At step A105, solution S0 is derived by learning SVM with the help of the training vector set W0. At step S110, a set T0 of unused training vectors is derived, where t representing a repeat count is set to t=0 and T represents all the data of the training vectors. The set T0 of the unused training vectors is obtained by removing T0 from T. As a result, T0=T−W0.

At step S115, it is determined whether the number of unused training vectors |Tt| reaches 0 or the number of used training data |Wt| becomes larger than a previously determined number “m”. It is noted that the symbol “| |” represents the number of elements in the set. When this determination is positive, the first phase is stopped and when it is negative, the process proceeds to step S120. At step S120, 59 training vectors are subjected to random sampling from among the set Tt of the unused training vectors. It is noted that the random sampling may be performed for any number of vectors, rather than 59.

At step S125, a training vector vt having the largest error amount Et(vk) is selected from among the 59 training vectors. In this case, the training vector vt can be derived by the following equations (2) and (3):

$$\begin{matrix}[ Equation 2 ] & \\ {v}_{t} = {arg max}_{{v}_{k}} \{ {E}_{t} ( {v}_{k} ) = {f}_{t} ( {v}_{k} ) - {y}_{k} \} & ( 2 ) \\ here , & \\ {f}_{t} ( {v}_{k} ) = {\sum }_{{v}_{i} ∈ {W}_{t}} {y}_{i} {α}_{i} K ( {v}_{i} , {v}_{k} ) + {b}_{t} , {y}_{k} = \{ - 1 , + 1 \} & ( 3 )\end{matrix}$$

At step S130, it is determined whether the error amount Et(vk) is smaller than a certain setting value ε. When this determination is positive, the first phase is stopped and when it is negative, the process proceeds to step S130. At step S135, the training vector vt is added to the used training vector Wt. On the other hand, the training vector vt is removed from the unused training vector Tt. As a result, Tt+1=Tt−vt. Subsequently, the process proceeds to step S140, at which the SVM is learned by the training vector Wt+1 so as to obtain a solution St+1. Thereafter, although not shown, depending on each case, the non-support vectors are removed based on the parameter α which is obtained based on the St+1. At step S145, the repeat count t is incremented by one. The process then returns to step S115 to repeat the aforementioned process again.

As obvious from the aforementioned description, in the first phase, the processes from step S115 to step S145 are repeated until the determinational step S115 or step S130 becomes positive. When the determination at step S115 or step S130 becomes positive, the first phase is stopped and the process moves to the second phase.

As described above, in the first phase, the best vector with respect to learning, i.e., the training vector vt having the largest error amount, is derived from among the randomly selected training vectors (59 vectors in the above example); the training vector vt is added to the already used training vector Wt so as to update to the training vector Wt+1; and the updated training vector Wt+1 is used to learn the SVM. Thus, an approximate solution of the SVM can be promptly derived.

Further, when the error amount is smaller than the setting value ε, the first phase is stopped. Thus, it becomes possible to avoid an unnecessary learning of SVM and also to speed up the learning, because the learning is performed by using a training vector having an error amount smaller than the setting value ε.

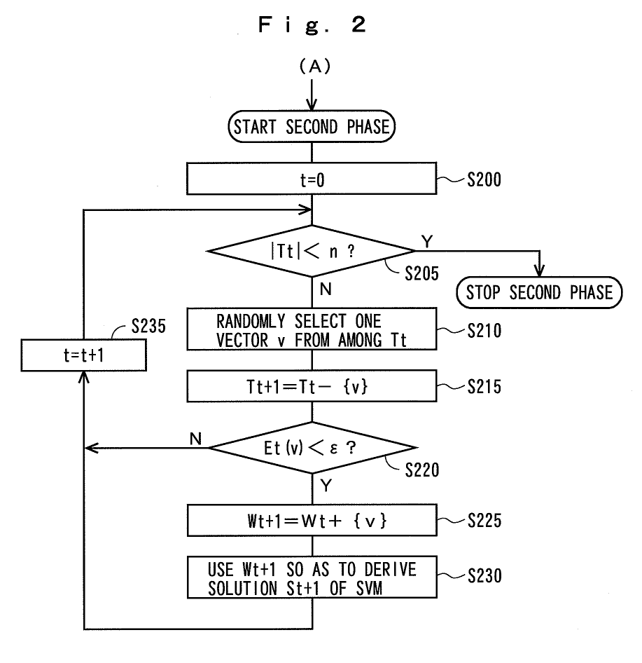

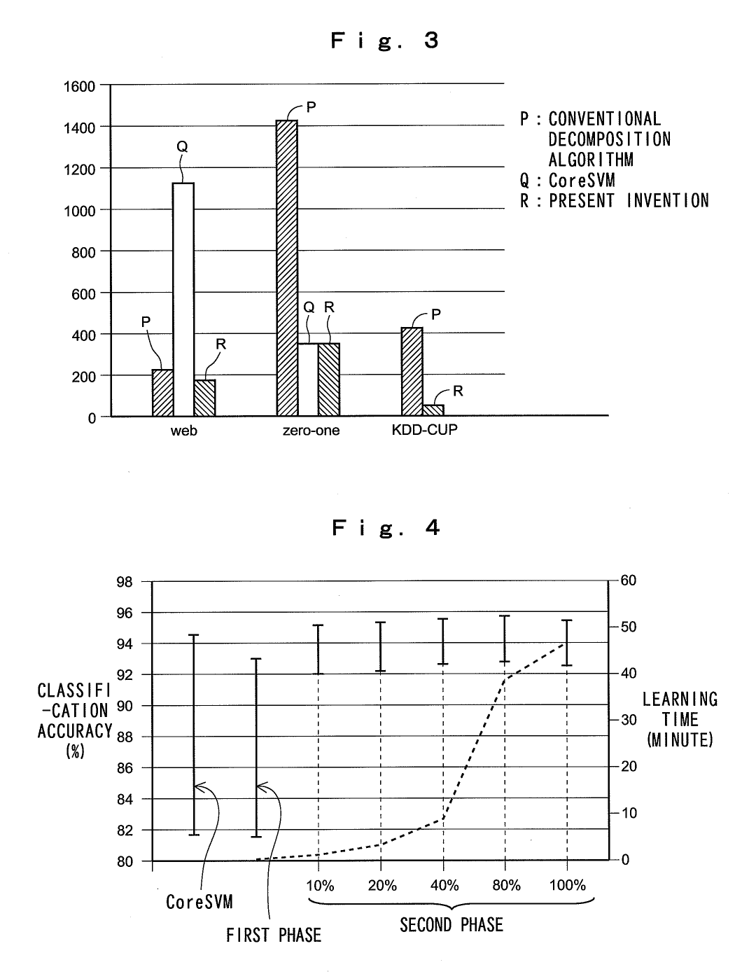

Subsequently, a process for the phase 2 will be described with reference to FIG. 2. In the phase 2, further learning is performed on the SVM that is learned in the first phase. At step S200, t=0. At step S205, it is determined whether the number of unused training vectors |Tt| is equal to or less than a certain setting value n. This process is a stopping condition for the SVM learning. When the magnitude of the setting value n is changed, it becomes possible to stop the second phase at the time that the proportion of the trained vectors (T0−Tt) to the total number T0 of the initial training vectors becomes 10%, 20%, 40%, 80% or 100%, for example (see FIG. 4 described later).

Initially, the determination at step S205 is negative, and thus, the process proceeds to step S210. At step S210, one training vector v is randomly selected from among the unused training vectors Tt. At step S215, the training vector v is removed from the unused training vector Tt. At step S220, it is determined whether the error amount Et (v) of the training vector v is larger than a certain value ε. When the error amount of the training vector v is less than ε, the determination at step S220 is negative. After t is incremented by one at step S235, the process returns to step S205, at which it is determined whether the number of unused training vectors |Tt| reaches equal to or less than the setting value n.

On the other hand, when the error amount Et(v) is larger than ε, the process proceeds to step S225. At step S225, the training vector v is further added to the already used training vector Wt, and the training vector is updated to Wt+1. At step S230, SVM learning is performed by using the updated training vector Wt+1 so that a solution St+1 is derived. Subsequently, t is incremented by one at step S230 and the process returns to step S205. Thereafter, the procedure from step S205 to step S235 mentioned previously is repeated, and when the determination at step S205 is positive, the second phase is stopped.

As obvious from the aforementioned description, in the second phase, learning is performed by using the training vector having an error amount larger than the value ε, and thus, the accuracy of SVM is maintained or improved, and by the process at step S205, the stopping condition in the second phase can be made appropriate.

Also, although the SMO is used for the processes at steps S105, S135 and S225, the learning efficiency improves greatly because the training data Wt is much smaller than all the training data T.

Subsequently, learning results by using “web,” “zero-one” and “KDD-CUP,” which are well known evaluation reference data sets are shown in FIG. 3. FIG. 3 is a graph in which a learning time is compared among the conventional decomposition algorithm (P), CoreSVM (Q), and a learning method (R) according to the present invention. Units on a vertical axis are seconds for “web” and “zero-one” and minutes for “KDD-CUP.” From this graph, it can be understood that when the learning method (R) of the present invention is used, it becomes possible to learn at a higher speed than using other conventional learning methods.

FIG. 4 shows classification accuracy and learning time (minutes) performed by using the evaluation reference data set, relative to the conventional CoreSVM, and the first phase and second phase (10%, 20%, 40%, 80% and 100%) of the present invention. The vertical axis on the left side represents classification accuracy and the vertical axis on the right side represents learning time (minutes). A solid line represents classification accuracy and a dotted line represents learning time. Regarding the classification accuracy, there is a variation of approximately 82% to 95% in the conventional CoreSVM. On the other hand, the variation results in the first phase of the present invention indicate a variation of approximately 82% to 93% and those in the second phase of the present invention (10%, 20%, 40%, 80% and 100%) indicate a variation of approximately 92% to 96%. From this, it can be understood that the variation even in the first phase is smaller than the conventional CoreSVM and even the first phase alone is comparable with the conventional CoreSVM. It is understood that in the second phase of the present invention, the variation is yet smaller than the conventional CoreSVM, and the accuracy greatly outperforms that in the conventional CoreSVM. It is noted that when the second phase of the present invention is executed merely by 10%, a high classification accuracy of equal to or more than 92% can be obtained. Moreover, the learning can be stopped in a short period of time. Thus, it is understood that a great effect can be obtained by executing merely 10% of the second phase.

1. A learning method for a support vector machine (hereinafter, SVM), comprising:
a step of selecting two training vectors from two opposite classes to learn an SVM;
a step of arbitrarily selecting a plurality of unused training vectors from a set of previously prepared training vectors to extract an unused training vector having a largest error amount;
a step of adding the extracted unused training vector to an already used training vector to update the training vector;
a step of learning the SVM by using the updated training vector; and
a step of stopping the learning when the number of updated training vectors is equal to or more than a predetermined number or when an error amount of the extracted unused training vector is smaller than a predetermined value.

2. The learning method for an SVM according to claim 1, wherein a step of removing a non-support vector is further added.

3. A learning method for an SVM, performed after the learning the SVM according to claim 1, the learning method comprising:
a step of arbitrarily selecting one training vector from a set of previously prepared training vectors;
a step of adding the training vector to an already used training vector to update the training vector when an error amount of the selected training vector is larger than a predetermined value;
a step of learning the SVM by using the updated training vector; and
a step of stopping the learning when the number of unused training vectors is smaller than the previously determined number.

4. A learning method for an SVM, performed after the learning the SVM according to claim 2, the learning method comprising:
a step of arbitrarily selecting one training vector from a set of previously prepared training vectors;
a step of adding the training vector to an already used training vector to update the training vector when an error amount of the selected training vector is larger than a predetermined value;
a step of learning the SVM by using the updated training vector; and
a step of stopping the learning when the number of unused training vectors is smaller than the previously determined number.

5. The learning method for an SVM according to claim 3, wherein
the number at the step of stopping can be arbitrarily changed.

6. learning method for an SVM according to claim 4, wherein the number at the step of stopping can be arbitrarily changed.
